(19) United States
(12) Patent Application Publication
(10) Pub. No.: US 2016/0052237 A1
(43) Pub. Date: Feb. 25, 2016

(54) Air Permeable Laminated Film and Manufacturing Method Therefor

(71) Applicants: Tae Hoon Kim, (US); EASYCHEM CO., LTD, Chungcheongbuk-do (KR)

(72) Inventors: Tae Hoon Kim, Daejeon (KR); Young Wook Kim, Daejeon (KR)

(21) Appl. No.: 14/783,930

(22) PCT Filed: Apr. 9, 2014
(86) PCT No.: PCT/KR2014/003085

§ 371 Date: Oct. 12, 2015

(30) Foreign Application Priority Data
Apr. 12, 2013 (KR) 10-2013-0040190

(51) Int. Cl. B32B 7/12; B32B 5/02; C09J 175/08; B32B 38/18; B32B 38/00; B32B 37/10; B32B 27/12; B32B 37/12

(52) U.S. Cl. CPC B32B 7/12; B32B 27/12; B32B 5/022; B32B 37/12; B32B 38/18; B32B 38/164; B32B 37/10; C09J 175/08; B32B 2262/0253; B32B 2307/724; B32B 2307/7265; B32B 2307/714; B32B 2437/00; B32B 2255/26

(57) ABSTRACT

Provided is an air permeable laminated film capable of being applied to anti-virus protective clothing, a protective film for a car coating, sportswear, and the like, and more particularly, an air permeable laminated film capable of improving strength and maintaining air permeability by laminating a reinforcement film such as a nonwoven fabric, a mesh film, or a fiber fabric, or the like, with an air permeable film using an air preamble polyurethane resin adhesive.

### TECHNICAL FIELD

The present invention relates to an air permeable laminated film and a manufacturing method therefor, and more particularly, to an air permeable laminated film capable of being applied to anti-virus protective clothing, a protective film for a car coating, sportswear, and the like. More particularly, the present invention relates to an air permeable laminated film capable of improving strength and maintaining air permeability by laminating a reinforcement film such as a nonwoven fabric, a mesh film, or a fiber fabric, or the like, with an air permeable film using an air preamble polyurethane resin adhesive, and a manufacturing method therefor.

### BACKGROUND ART

Since an existing air permeable laminated film uses an adhesion method using an adhesive that is not air permeable, in order to allow a film to have air permeability, there is a need to use a method for laminating the film with a roll having a checked pattern to allow air to pass through a surface on which an adhesive is not adhered. In this case, there are disadvantages in that an apparatus is complicated and as a result, air permeability is also deteriorated, and an area of portions of the surface where the adhesive is not adhered is significantly wide, such that a product having poor anti-virus capability or moisture barrier capability, or the like, cannot but be manufactured.

An air permeable laminated film manufactured by applying an adhesive having a predetermined pattern on one surface of a first air permeable film and stacking and laminating a second air permeable film, and a manufacturing method therefor have been disclosed in Korean Patent No. 10-1013945 (Patent Document 1). In order to apply the adhesive having a predetermined pattern as described above, the adhesive is applied using a copper plate roller having a groove formed therein. However, it is not easy to form a uniform pattern and a virus or moisture barrier property may be deteriorated.

Therefore, the present inventor has conducted many studies, and as a result, even in the case of coating an entire surface using a specific polyurethane composition as in the present invention, since an adhesive has air permeability, air may pass through a fine air permeable adhesive layer, that is, air permeability of the adhesive itself is excellent, such that at the time of lamination, an entire surface of an adherend may be coated and laminated, and thus, anti-virus performance or chemical resistance as well as air permeability may be more excellent.

### RELATED ART DOCUMENT

(Patent Document 1) Korean Patent No. 10-1013945

### DISCLOSURE

### Technical Problem

An object of the present invention is to provide a laminated film capable of being laminated by coating an entire surface of an adherend using an adhesive having excellent air permeability on an air permeable film at the time of lamination to thereby have more excellent anti-virus performance or chemical resistance as well as air permeability.

### Technical Solution

In one general aspect, there is provided a laminated film capable of being used in anti-virus protective clothing, a protective film for a car coating, sportswear, and the like. More particularly, there is provided an air permeable laminated film capable of increasing durability and strength, improving air permeability at the time of lamination, and having excellent anti-virus capability or chemical resistance by laminating three layers of an air permeable film/an air permeable polyurethane (PU) adhesive/a reinforcement film such as a nonwoven fabric, a mesh film, or a fiber fabric.

The present inventors found that polyurethane may have air permeability as an air permeable polyurethane (PU) adhesive while moisture is absorbed and diffused, only if a polyol component including polyethylene glycol diol, polypropylene glycol diol, or a mixed diol component thereof is used as a diol monomer of the polyurethane, thereby completing the present invention. Any diol may be used as long as the diol has a weight average molecular weight of about 100 to 500,000 g/mol. In the case of using the air permeable PU adhesive having the above-mentioned structure, since a portion on which the adhesive is adhered may also have air permeability, an entire surface of an adherend may be coated and laminated. In this case, the air permeable laminated film may have anti-virus performance or prevent permeation of blood at the time of operation in the case of applying the film in a medical field, and the air permeable PU adhesive may simultaneously have an adhesion function and an air permeable function.

Further, water vapor permeability of the air permeable laminated film according to the present invention measured according to the method of ASTM E96 may be 100 to 20,000 g/m²×24 hrs.

Hereinafter, each configuration of the present invention will be described in detail.

First, as the air permeable film according to the present invention, an air permeable film manufactured by mixing an inorganic material such as calcium carbonate, or the like, with polyolefin, extruding the mixture, and stretching the extruded material, an air permeable film manufactured by mixing an organic solvent such as a lubricant, a plasticizer, wax, oil, or the like, with polyolefin, extruding the mixture, stretching the extruded material, and then extracting the organic solvent using a solvent, or the like, may be used. That is, any air permeable polyolefin film may be used as long as it is generally used in the art. In the present invention, as a polyolefin resin, one or more compounds selected from the group consisting of homopolymers including low-density polyethylene, linear low-density polyethylene, medium-density polyethylene, and high-density polyethylene, or copolymers containing ethylene as a component, polypropylene homopolymers or copolymers containing propylene as a main component, and polybutene may be preferably used.

Next, as the reinforcement film according to the present invention, any material selected from a nonwoven fabric made of spunbond, spunlace, or the like, a mash film, or a fiber fabric may be used. As a representative example, the nonwoven fabric will be described below. The nonwoven fabric means a nonwoven fabric manufactured by a general spunbond method or spunlace method. Although not limited, spunbond made of any one resin selected from polyester, nylon, polyethylene, and polypropylene, more preferably, a polypropylene resin may be preferably used, and a nonwoven fabric manufactured using the general spunbond method or spunlace method may be used. For example, a spunbond nonwoven fabric having a basis weight of 10 to 300 gsm may be used. According to the present invention, excellent air permeability may also be implemented by using the nonwoven fabric as described above. In more detail, the reinforcement film may be a spunbond nonwoven fabric or spunlace nonwoven fabric made of a polyethylene, polypropylene, polyester, or nylon material, or the like, or a mesh film or fiber fabric made of an organic polymer material.

Next, the air permeable polyurethane according to the present invention will be described.

The air permeable polyurethane adhesive according to the present invention may include the polyol containing the diol component selected from polyethylene glycol diol, polypropylene glycol diol, or the mixed diol component thereof, and isocyanate. Preferably, the air permeable polyurethane adhesive may further include a chain extender, a catalyst, and an organic solvent. Since a polymerization method for the air permeable polyurethane according to the present invention is a solution polymerization method, or the like, generally known in the art, a detailed description thereof will be omitted.

In view of the object of the present invention, it is suitable that an air permeable polyurethane resin (adhesive) according to the present invention may have water vapor permeability in a range of 100 to 50,000 g/m²×24 hrs (ASTM E96).

In the air permeable polyurethane resin (adhesive) according to the present invention, as the polyol, a polyol component including polyethylene ether glycol diol, polypropylene ether glycol diol, or a mixed diol component thereof may be used, and a weight average molecular weight of the diol may be in a range of 100 to 500,000. In addition, air permeability may be maintained by using the polyol component including polyethylene ether glycol diol, polypropylene ether glycol diol, or the mixed diol component thereof in a content range of 10 to 90 parts by weight based on 100 parts by weight of a solid content of an air permeable polyurethane adhesive composition.

As the isocyanate of the air permeable polyurethane resin (adhesive) according to the present invention, one or more of 1,6-hexamethylene diisocyanate (HDI), isophoronediisocyanate (IPDI), m-xylenediisocyanate (m-XDI), hydrogenated diphenylenedimethylenediisocyanate (H₁₂MDI), and m-tetramethylxylenediisocyanate (m-TMXDI) may be used together.

As the chain extender of the air permeable polyurethane resin (adhesive) according to the present invention, one or more of ethyleneglycol (EG), 1,4-butanediol (1,4-BD), 1,6-hexanediol (1,6-HD), 1,2-propyleneglycol (1,2-PG), 1,3-propanediol (1,3-PDO), neopentylglycol (NPG), 2-methyl-1,3-propanediol (2-MPD), 3-methyl-1,5-pentanediol (3-MPD), 2-butyl-2-ethyl-1,3-propanediol (BEPD), and the like, may be used together, but the chain extender is not limited thereto. In the case of using the chain extender, it is preferable that a content thereof is 0.01 to 5 parts by weight based on 100 parts by weight of the total solid content, but the content is not necessarily limited thereto.

As a catalyst at the time of preparing the air permeable polyurethane resin (adhesive) according to the present invention, a catalyst used in a polyurethane industry may be used, but is not limited to a specific catalyst. In addition, the catalyst may not be used.

As an organic solvent at the time of preparing the air permeable polyurethane resin (adhesive) according to the present invention, one of acetone, toluene, xylene, ethyl acetate, 2-butanone, cyclohexanone, N,N-dimethylacetamide, N,N-dimethylformamide, N-methylpyrrolidone, dichloromethane, ethanol, isopropyl alcohol, and methanol may be used alone or a mixture of at least two thereof may be used.

In the present invention, it is preferable to use a solution of the air permeable polyurethane adhesive composition in which a solid content is 1 to 90 wt %, preferably, 10 to 85 wt %, and as a coating method, a roll coating method, a dip coating method, a flow coating method, a gravure coating method, a slot die-coating method, or the like, capable of coating the entire surface may be used.

Particularly, according to the present invention, resistance against moisture in addition to strength may be simultaneously improved by stacking the reinforcement film and the air permeable film using the air permeable polyurethane adhesive, and at the time of lamination, air permeability may be maintained, and adhesive strength may be improved, such that the air permeable laminated film may have an additional effect of preventing each of the layers from being separated even in the case of long-term use, and thus, the air permeable laminated film may be stably used for a long period of time.

Further, according to the present invention, at the time of manufacturing the air permeable film, an antioxidant and a UV stabilizer may be added as components of the adhesive, such that an effect of preventing oxidation by sunlight may be more improved. In the case of using the antioxidant and the UV stabilizer, it is preferable that contents thereof are 0.01 to 5 parts by weight based on 100 parts by weight of the total solid content, but the contents are not necessarily limited thereto.

According to the present invention, if necessary, a generally used resin additive, for example, a plasticizer, a lubricant, an antistatic agent, a pigment, a UV absorber, an anti-fogging agent, an antihaze agent, a heat stabilizer, an anti-blocking agent, a dye, a whitening agent, a drying agent, a fluorescent agent, other insulators, or the like, may be added to the adhesive.

Hereinafter, a manufacturing method for an air permeable laminated film according to the present invention will be described.

The manufacturing method for a laminated film includes:

A) preparing an air permeable film;

B) coating a solution of a polyurethane adhesive according to the present invention on one surface or both surfaces of the air permeable film;

c) adhering a reinforcement film onto the surface of the air permeable film on which a solution of the polyurethane adhesive is coated; and

d) rolling and drying the resultant film.

### ADVANTAGEOUS EFFECTS

A laminated film according to the present invention may have excellent durability and anti-virus performance and prevent permeation of moisture, and since the laminated film is adhered by an air permeable adhesive through an entire surface thereof, compounds may not permeate through the laminated film, such that chemical resistance may be improved.

### BEST MODE

Hereinafter, the present invention will be described in detail through Examples.

### EXAMPLE 1

A compound resin containing a commercialized polyolefin resin as a main component and having a calcium carbonate content of about 50% was purchased, T-die extruded using a film extruder, and stretched at a stretching ratio of 2.5:1, thereby obtaining an air permeable film having a basis weight of 30 gsm. A result of measuring water vapor permeability of the air permeable film was 7000 g/m²×24 hrs. A commercialized polypropylene nonwoven fabric having a basis weight of 30 gsm was prepared.

Then, after methylene diisocyanate and a catalyst, and polyethylene ether glycol diol and 1,4-butanediol were dissolved in ethylacetate used as a reaction solvent at a ratio of 90:10 (parts by weight) so as to have a solid content of 60 wt %, the mixture was stirred at 80° C. for 1 hour, and cooled, thereby preparing an air permeable PU adhesive. A viscosity of the prepared air permeable PU adhesive was 2,500 cps at 25° C. After the air permeable film and the polypropylene nonwoven fabric were laminated by coating the prepared air permeable PU adhesive on an entire surface of the air permeable film using a roll coating method, the laminated film passed through a roller, and was pressurized to thereby be additionally laminated. Then, the laminated film was dried at a temperature of 60° C. thereby completing a product. As a result, peel strength of the laminated film measured using a tensile machine was 650 (g/inch), water vapor permeability thereof was 5500 g/m²×24 hrs (ASTM E96), and the laminated film successfully passed an antibacterial test performed according to JIS Z 2801.

### Comparative Example 1

A general commercialized PU adhesive (Toyo Ink Korea, TM-386) was purchased, and the air permeable film and the polypropylene nonwoven fabric were laminated by partially adhering the air permeable film and the polypropylene nonwoven fabric in a checked pattern using a gravure adhesion method. Then, water vapor permeability of the laminated film was compared. As a result of evaluating the laminated film according to the same standards as in Example 1, peel strength thereof was 320 (g/inch), water vapor permeability thereof was 2800 g/m²×24 hrs (ASTM E96), and the laminated film did not pass the antibacterial test (JIS Z 2801).

Although the exemplary embodiments of the present invention have been disclosed in detail, those skilled in the art will appreciate that various modifications are possible, without departing from the scope and spirit of the present invention as disclosed in the accompanying claims. Therefore, the present invention is not limited to the above-mentioned exemplary embodiments.

1. An air permeable laminated film comprising a reinforcement film layer, an air permeable film layer, and a polyurethane adhesive layer formed between the reinforcement film layer and the air permeable film layer,
wherein the polyurethane adhesive layer is made of a polyurethane adhesive prepared using a polyol including polyethylene glycol diol or polypropylene glycol diol having a weight average molecular weight of 100 to 500,000 g/mol, or a mixed diol component thereof.

2. The air permeable laminated film of claim 2, wherein a content of the polyol is 10 to 90 parts by weight based on 100 parts by weight of a solid content of the polyurethane adhesive composition.

3. The air permeable laminated film of claim 1, wherein the air permeable film is a film manufactured by mixing inorganic particles with a polyolefin resin and stretching the mixture, or a film manufactured by mixing an organic solvent with a polyolefin resin, stretching the mixture, and then, extracting the organic solvent.

4. The air permeable laminated film of claim 1, wherein the reinforcement film is a spunbond nonwoven fabric or spunlace nonwoven fabric made of a polyethylene, polypropylene, polyester, or nylon material, or a mesh film or fiber fabric made of an organic polymer material.

5. The air permeable laminated film of claim 1, wherein water vapor permeability of the laminated film measured according to a method of ASTM E96 is 100 to 20,000 g/m²×24 hrs.

6. A manufacturing method for an air permeable laminated film, the manufacturing method comprising:
a) preparing an air permeable film;
b) coating a solution of a polyurethane adhesive prepared using a polyol including polyethylene glycol diol, polypropylene glycol diol, or a mixed diol component thereof on one surface or both surfaces of the air permeable film;
c) adhering a reinforcement film onto the surface of the air permeable film on which a solution of the polyurethane adhesive is coated; and
d) rolling and drying the resultant film.

7. The manufacturing method of claim 6, wherein the diol has a weight average molecular weight of 100 to 500,000 g/mol.

8. The manufacturing method of claim 6, wherein the air permeable polyurethane adhesive has water vapor permeability in a range of 100 to 50,000 g/m²×24 hrs (ASTM E96).

9. The manufacturing method of claim 6, wherein water vapor permeability of the laminated film measured according to a method of ASTM E96 is 100 to 20,000 g/m²×24 hrs.
